(19) United States
(12) Patent Application Publication
(10) Pub. No.: US 2007/0239506 A1
(43) Pub. Date: Oct. 11, 2007

(54) Priority based scheduling system

(75) Inventors: Frank L. Jania, Chapel Hill, NC (US); Mary S. Johnson, Raleigh, NC (US); Karen R. Kluttz, Raleigh, NC (US); Martha J. Newport, Carrboro, NC (US); Kristine J. Olka, Raleigh, NC (US)

Correspondence Address: HARRINGTON & SMITH, PC, 4 RESEARCH DRIVE, SHELTON, CT, 06484-6212, US

(73) Assignee: International Business Machines Corporation

(21) Appl. No.: 11/400,253

(22) Filed: Apr. 6, 2006

(51) Int. Cl. G06F 9/46

(52) U.S. Cl. 705/8

(57) ABSTRACT

A computer program product, electronic device and method are provided that incorporate a hierarchical structure of priority ranks for presenting a scheduling user with a relationship-based display of a schedule for another user. A priority rank of a scheduling user is determined. A view of a schedule of at least one other user is displayed, wherein the view shows scheduled events of the at least one other user that are selected at least partially in accordance with the determined priority rank of the scheduling user. Preferably the view shows scheduled of the at least one other user that correspond to a priority rank of greater importance than the determined priority rank of the scheduling user. Preferably the view does not show scheduled events of the at least one other user that correspond to a priority rank of lower importance than the determined priority rank of the scheduling user.

### TECHNICAL FIELD

The teachings in accordance with the exemplary embodiments of this invention relate generally to computer systems and software and, more specifically, relate to computer systems and software for scheduling.

### BACKGROUND OF THE INVENTION

In a typical organization, meetings are often an integral part of conducting business. Due to the importance of meetings, various systems and computer software have been developed that enable individuals in an organization to more easily schedule meetings. For example, systems and software of this nature include: Lotus Notes® Calendar and Scheduling, Office Tracker, Meeting Maker®, and Resource Scheduler. These systems utilize interfaces that act as proxies for the individuals. That is, one can use the systems or software to schedule a meeting with other individuals (e.g. invitees) without first consulting other individuals. Some of these systems or software provide that such unilateral scheduling must subsequently be confirmed or accepted by the invitee(s).

The current state of these proxies may be considered to be static and binary. The person scheduling the meeting either has complete access to the availability information of invitees (e.g. schedules) or none at all. This limited information can hamper effective scheduling. Therefore, there is a need to improve current scheduling systems.

### SUMMARY

In an exemplary aspect of the invention, a computer program product and method are provided. The computer program product comprises program instructions embodied on a tangible computer-readable medium, whereby execution of the program instructions results in a series of operations. The series of operations, and a corresponding method, comprise: determining a priority rank of a scheduling user; and displaying a view of a schedule of at least one other user, wherein the view shows scheduled events of the at least one other user that are selected at least partially in accordance with the determined priority rank of the scheduling user. Preferably the view does not show scheduled events of the at least one other user that correspond to a priority rank of lower importance than the determined priority rank of the scheduling user.

In another exemplary aspect of the invention, an electronic device is provided. The electronic device comprises: at least one memory; at least one data processor coupled to the at least one memory; at least one display device coupled to the at least one data processor; and a view function executable by the at least one data processor. The view function comprises a set of operations comprising: determining a priority rank of a scheduling user; and displaying a view of a schedule of at least one other user, wherein the view shows scheduled events of the at least one other user that are selected at least partially in accordance with the determined priority rank of the scheduling user. The view preferably shows scheduled events of the at least one other user that correspond to a priority rank of greater importance than the determined priority rank of the scheduling user, and preferably the view does not show scheduled events of the other user that correspond to a priority rank of lower importance than the determined priority rank of the scheduling user.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows a conventional scheduling software interface wherein the manager attempting to schedule a meeting with the employees has chosen to show the employees' schedules;

FIG. 2 shows the conventional scheduling software interface of FIG. 1 wherein the manager has chosen not to show the employees' schedules;

FIG. 3 shows a conventional scheduling software interface wherein textual descriptions are provided concerning pre-scheduled time slots;

FIG. 4 shows a Lotus Notes® Calendar and Scheduling Preferences dialogue;

FIG. 5 depicts an exemplary scheduling software interface incorporating features of this invention that Vice President (VP) Fred is presented with when attempting to schedule a meeting with Employee Jennifer and/or Employee Sam;

FIG. 6 depicts an exemplary scheduling software interface incorporating features of this invention that Manager Bob is presented with when attempting to schedule a meeting with Employee Jennifer and/or Employee Sam;

FIG. 7 depicts an exemplary scheduling software interface incorporating features of this invention that Employee Ted is presented with when attempting to schedule a meeting with Employee Jennifer and/or Employee Sam;

FIG. 8 depicts an exemplary See Same Rank (SSR)-enabled scheduling software interface incorporating features of this invention that VP Fred is presented with when attempting to schedule a meeting with Employee Jennifer and/or Employee Sam;

FIG. 9 depicts an exemplary SSR-enabled scheduling software interface incorporating features of this invention that Manager Bob is presented with when attempting to schedule a meeting with Employee Jennifer and/or Employee Sam;

FIG. 10 depicts an exemplary SSR-enabled scheduling software interface incorporating features of this invention that Employee Ted is presented with when attempting to schedule a meeting with Employee Jennifer and/or Employee Sam;

FIG. 11 is a flowchart illustrating an exemplary method for practicing exemplary embodiments of the invention;

FIGS. 12A-12C show a flow chart illustrating an alternate exemplary method for practicing the exemplary embodiments of this invention;

FIG. 13 is a simplified block diagram of various electronic devices that are suitable for use in practicing exemplary embodiments of the invention as connected to a Network;

FIG. 14 is a simplified block diagram of various electronic devices that are suitable for use in practicing exemplary embodiments of the invention as connected to the internet;

FIG. 15 is a simplified block diagram showing an exemplary set of software interactions involved in implementing various embodiments of the invention; and

FIG. 16 is a simplified block diagram showing an alternate exemplary set of software interactions involved in implementing various embodiments of the invention.

### DETAILED DESCRIPTION

Assume as a non-limiting example that a manager of a division desires to schedule a meeting with division members. In this case, it would be very likely that the manager's meeting would take precedence over most other meetings the division members might have that would otherwise conflict with the manager's meeting. Under conventional scheduling systems, when the manager attempts to schedule the meeting, the manager will be presented with either information concerning the preexisting availability of all of the division members or no information at all. Assume that one of the division members has a more important meeting scheduled, such as a meeting with a Vice President, for example. Under the current systems, there is no accessible means by which the manager will be presented with this information. That is, the manager would have to either adhere to all of the division members' individual availability or ignore all of the division members' individual availability, regardless of whether or not any division member has a more important meeting already scheduled.

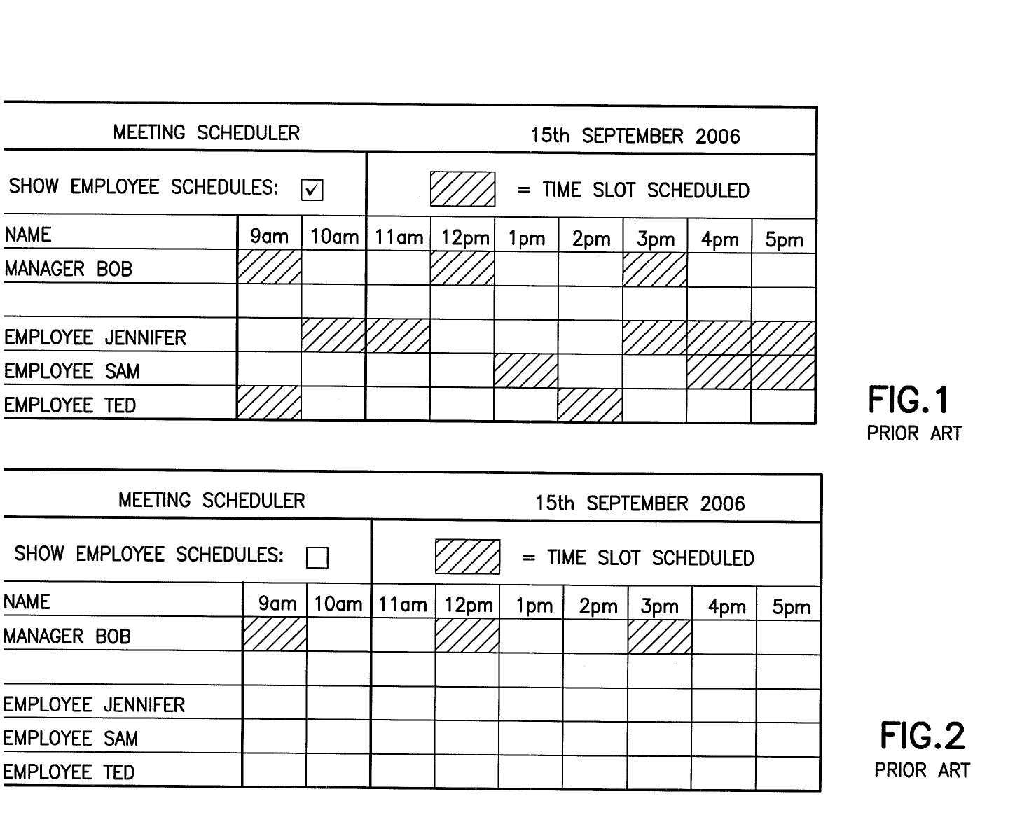

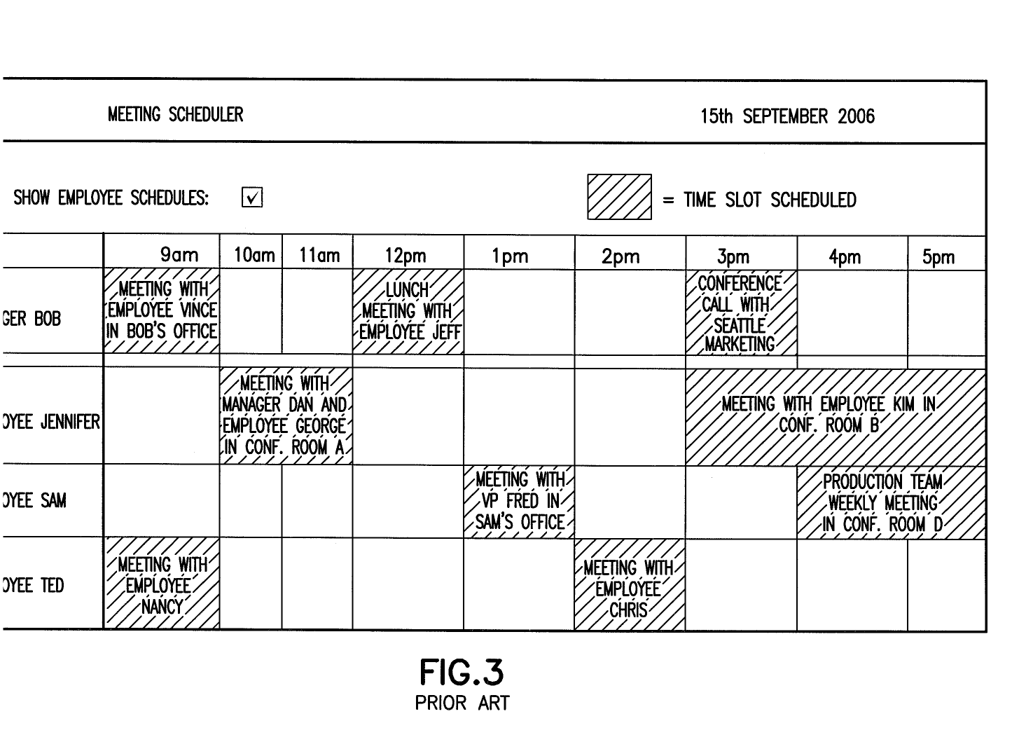

FIGS. 1 and 2 illustrate the limited information available under conventional systems. In FIGS. 1 and 2, Manager Bob is attempting to use the Meeting Scheduler software to schedule a one hour manager meeting on Sep. 15, 2006 with Employee Jennifer, Employee Sam and Employee Ted. As shown in FIGS. 1 and 2, Manager Bob has two choices concerning the employee schedule information he is provided.

FIG. 1 shows the Meeting Scheduler interface when Manager Bob has chosen to show the employee schedules by checking the appropriate checkbox. Manager Bob is able to see other meetings the three employees already have scheduled. However, the scheduling software does not provide Manager Bob with any information concerning the relative importance of the scheduled employee meetings. That is, Manager Bob, thinking that the manager meeting is more important than the other employees' meetings, may desire to schedule the manager meeting at 1 pm even though Employee Sam has a meeting already scheduled for that time slot. Manager Bob may schedule the manager meeting for the 1 pm time slot without knowing that Employee Sam's 1 pm meeting is with Vice President Fred and takes precedence over the manager meeting.

FIG. 2 shows the Meeting Scheduler interface when Manager Bob has chosen not to show the employee schedules by unchecking the appropriate checkbox. In this interface, Manager Bob is not presented with any information concerning scheduled meetings the employees may already have.

Current scheduling systems may attempt to address this problem by providing labels or text for the pre-scheduled time slots. That is, when attempting to schedule a meeting, Manager Bob may be able to see a textual description of the scheduled meetings the invitees' already have. FIG. 3 depicts a Meeting Scheduler interface in which the pre-scheduled time slots contain textual descriptions. When attempting to schedule the manager meeting, Manager Bob can see what types of meetings the invitees already have that potentially conflict with the manager meeting. However, this system, as with FIGS. 1 and 2, is similarly all or nothing. Manager Bob must read all of the descriptions and sift through all of the information provided in order to schedule the manager meeting. This is inefficient and wasteful of Manager Bob's time.

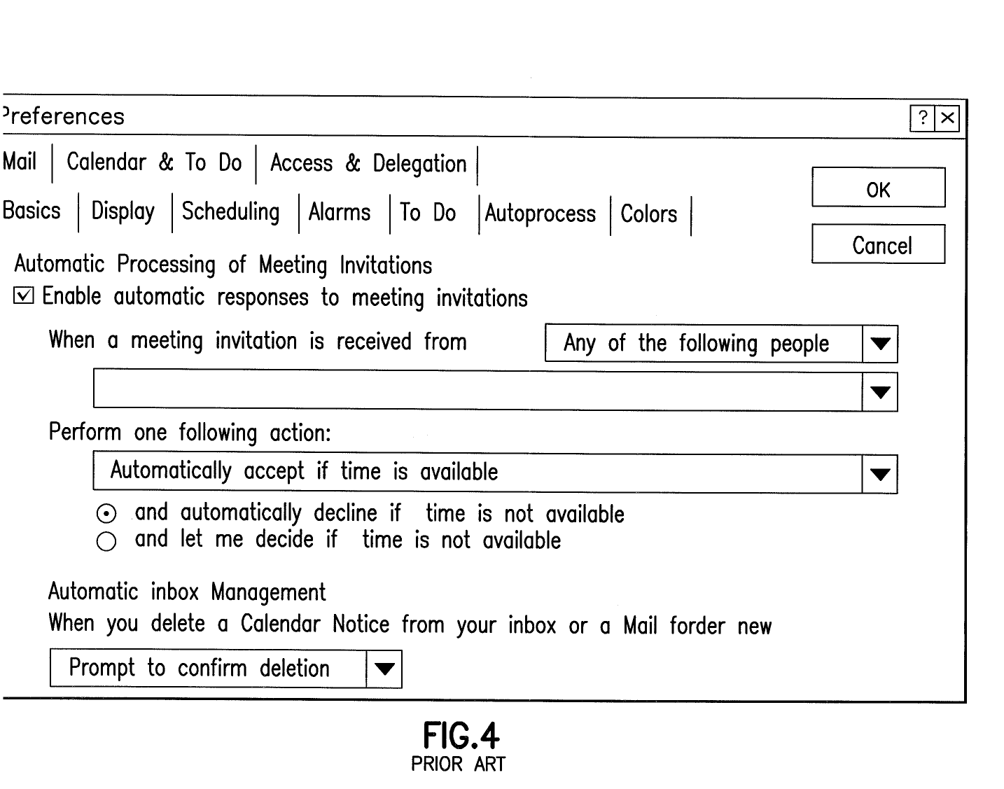

As shown in FIG. 4, Lotus Notes® Calendar and Scheduling provides autoprocessing options. These options enable a user to set preferences that automatically process meeting invitations. These preferences can be set to automatically accept or decline invitations from select scheduling users or groups. However, this system does not assist a scheduling user when the scheduling user attempts to schedule a meeting with invitees.

Some scheduling systems known to the inventors may enable an administrator to set permissions for the system users. These permissions can include such capabilities as being allowed to alter or change scheduled meetings of others. Some scheduling systems may also provide security capabilities that limit users' access to the system. Some scheduling systems may enable a scheduling user to select whether an invitee is required to attend a scheduled meeting or whether the invitee's presence is optional.

As is apparent, current scheduling methods and software provide limited information and options when a scheduling user attempts to schedule meetings. This limited information may hamper efficient scheduling, effectively making it more difficult to schedule meetings around invitees' schedules.

It would therefore be desirable to provide techniques that provide more relevant information and options to a scheduling user attempting to schedule a meeting with invitees using scheduling software. To accomplish this, a computer program product, electronic device and method are provided that incorporate a hierarchical structure of priority ranks to present various priority ranks of users with a relationship-based display of user schedules. Scheduling users are supplied with relevant information concerning the availability of an invitee for a meeting with the scheduling user based on the relative priority rank assigned to the scheduling user.

As used herein, the availability data of a user may be displayed by showing a schedule of the user with scheduled events identified in accordance with aspects of exemplary embodiments of the invention. In addition, as used herein, the term “hierarchy” refers to a relationship-based system wherein items can be ordered according to a priority rank assigned to the item. As discussed herein, priority ranks are based on the relative importance of the associated item. In other embodiments, priority ranks may be based on a different criterion or criteria.

FIGS. 5-7 depict an exemplary scheduling software interface incorporating features of the invention. FIGS. 5-7 show three different views of the availability information for the same people, Employee Jennifer and Employee Sam. Each of the three figures presents different information based on the priority rank of the scheduling user who is requesting a meeting. For FIGS. 5-7, Employee Jennifer has activated the relationship-based display for her scheduling software whereas Employee Sam has not. As such, the availability shown for a meeting with Employee Jennifer will vary based on the priority rank of the scheduling user. In contrast, the availability shown for a meeting with Employee Sam will not vary. Furthermore, the hierarchical structure of priority ranks for FIGS. 5-7, from the most important priority rank to the least important priority rank, comprises: Vice President (VP), Manager and Employee.

FIG. 5 illustrates an exemplary scheduling software interface VP Fred is presented with when attempting to schedule a meeting with Employee Jennifer and/or Employee Sam. Employee Jennifer has classified VP Fred as among the most important people who can schedule a meeting with her. Hence, Employee Jennifer's availability data has been modified to show that she is free for a meeting with VP Fred at any time of the day. Since Employee Sam has not activated the relationship-based display for his scheduling software, Employee Sam's availability data remains unfiltered, regardless of who is attempting to schedule a meeting with him. Thus VP Fred is presented with Employee Sam's actual, unfiltered schedule.

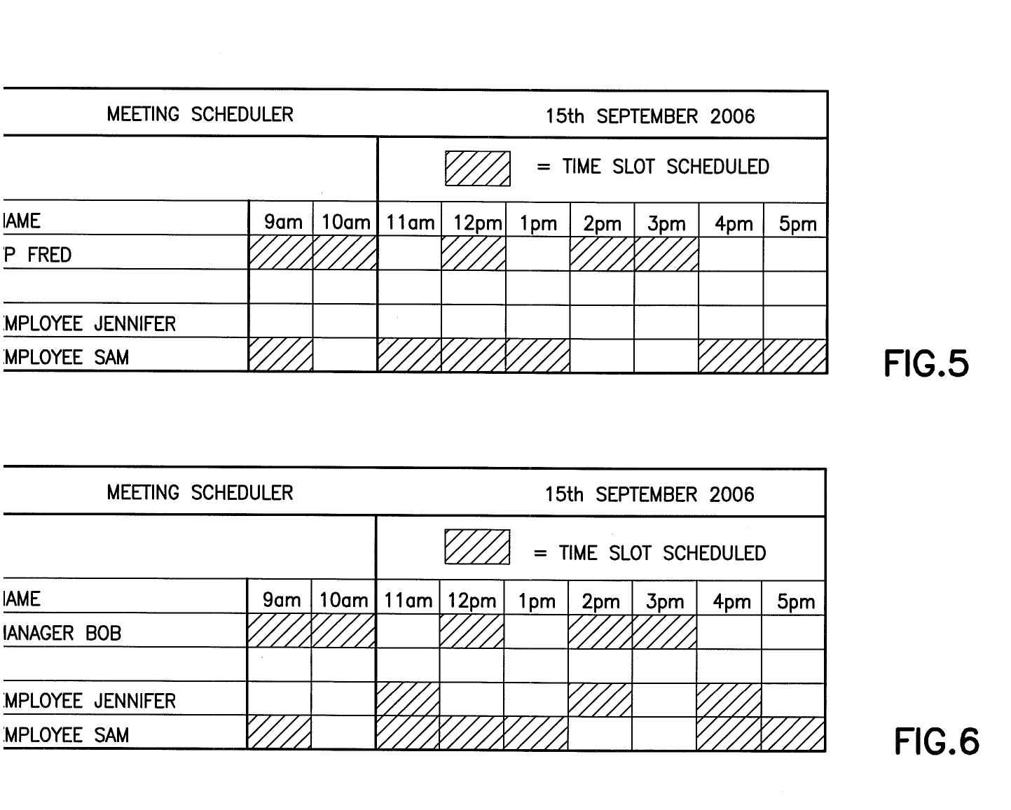

FIG. 6 depicts an exemplary scheduling software interface Manager Bob is presented with when attempting to schedule a meeting with Employee Jennifer and/or Employee Sam. Employee Jennifer has classified Manager Bob as important, but not quite as important as three other people. with whom Employee Jennifer has already scheduled meetings. Hence, Employee Jennifer's availability data has been modified to show that she is free for a meeting with Manager Bob at any time except 11 am, 2 pm and 4 pm, when she has meetings already scheduled with more important people. As above, since Employee Sam has not activated the relationship-based display for his scheduling software, Employee Sam's availability data remains unfiltered, regardless of who is attempting to schedule a meeting with him.

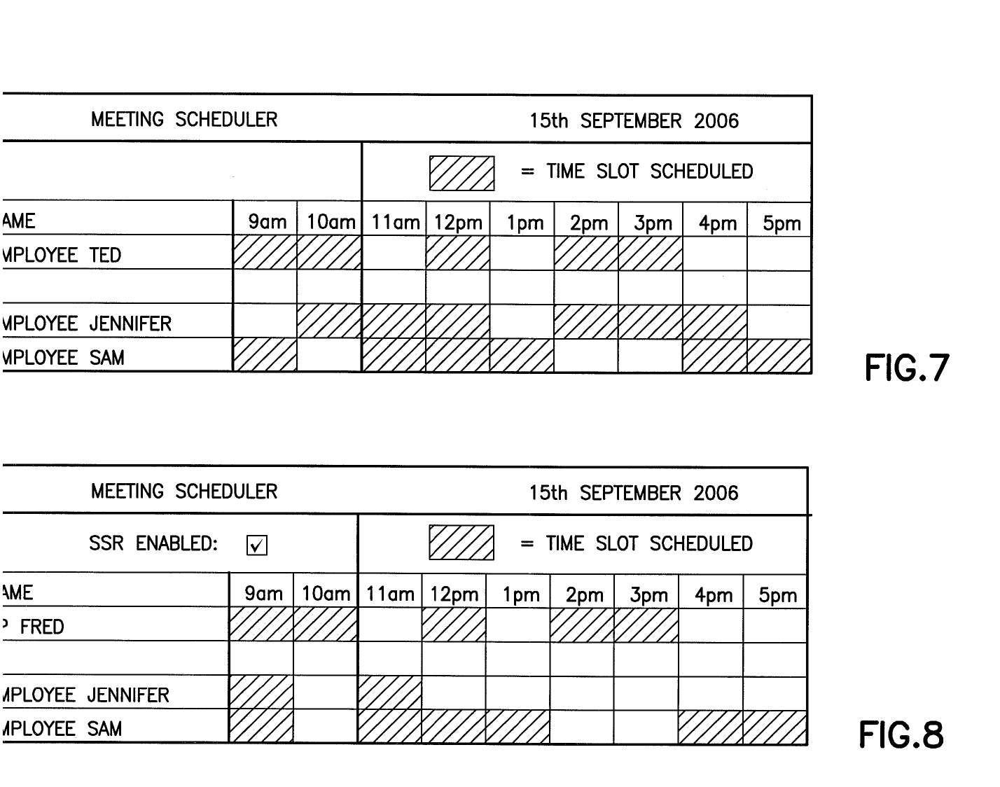

FIG. 7 depicts an exemplary scheduling software interface Employee Ted is presented with when attempting to schedule a meeting with Employee Jennifer and/or Employee Sam. Employee Jennifer has classified Employee Ted as among the least important priority rank of users. Hence, Employee Ted is presented with Employee Jennifer's true or entire meeting schedule. This availability data shows that Employee Jennifer already has meetings scheduled for every time slot of Sep. 15, 2006 except 9 am, 1 pm and 5 pm. As with VP Fred and Manager Bob, Employee Ted is presented with Employee Sam's actual, unfiltered availability data.

Alternate exemplary embodiments of the invention incorporate an additional option herein referred to as the See Same Rank (SSR) option. When enabled, the SSR option allows a scheduling user to see scheduled meetings an invitee already has with other users of at least the same priority rank as the scheduling user. In such a manner, a scheduling user of a given priority rank accords other users of that same priority rank equal importance and recognition.

FIGS. 8-10 depict an exemplary scheduling software interface incorporating features of the invention. In the exemplary scheduling software of FIGS. 8-10, the scheduling users have enabled the SSR option. As in FIGS. 5-7, FIGS. 8-10 show three different views of the availability data for the same people, Employee Jennifer and Employee Same, each view based on the priority rank of the scheduling user who is requesting a meeting. Also as above, for FIGS. 8-10 Employee Jennifer has activated the relationship-based display for her scheduling software whereas Employee Sam has not and the hierarchical structure of priority ranks, from the most important priority rank to the least important priority rank, comprises: Vice President (VP), Manager and Employee.

FIG. 8 illustrates an exemplary SSR-enabled scheduling software interface VP Fred is presented with when attempting to schedule a meeting with Employee Jennifer and/or Employee Sam. Employee Jennifer has classified VP Fred as among the most important people who can schedule a meeting with her. In the interface, Employee Jennifer's availability data has been modified to show that she already has two meetings scheduled that day, at 9 am and 11 am, with one or more other persons of the same priority rank as VP Fred, namely one or more other VPs. Hence, VP Fred is presented with Employee Jennifer's availability data showing scheduled meetings Employee Jennifer has with other VPs. This is in contrast to the availability data shown in FIG. 5, where VP Fred cannot see scheduled meetings Employee Jennifer has with other VPs. As in FIGS. 5-7, since Employee Sam has not activated the relationship-based display for his scheduling software, Employee Sam's availability data remains unfiltered, regardless of who is attempting to schedule a meeting with him and VP Fred is presented with Employee Sam's actual, unfiltered schedule.

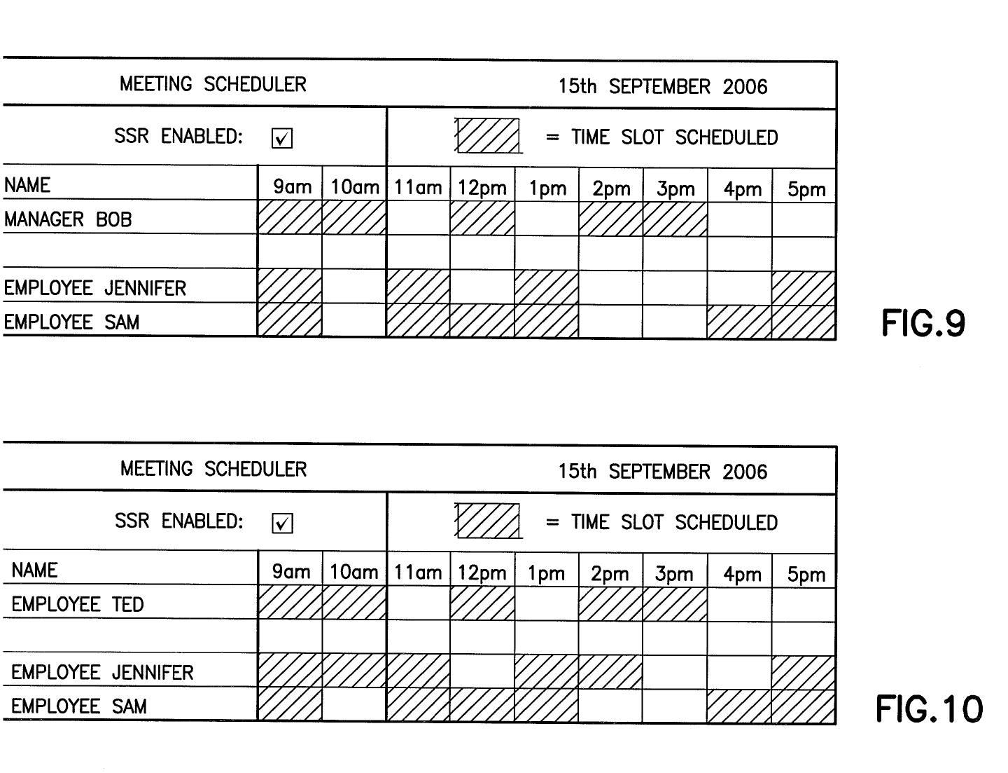

FIG. 9 depicts an exemplary SSR-enabled scheduling software interface Manager Bob is presented with when attempting to schedule a meeting with Employee Jennifer and/or Employee Sam. Employee Jennifer has classified Manager Bob as the middle priority rank. Since the SSR option is enabled, Employee Jennifer's availability data has been modified to show scheduled meetings she already has that day with others whose priority rank is equivalent to or higher than that of Manager Bob. The data Manager Bob is shown reflects this by showing that Employee Jennifer has meetings scheduled for 9 am, 11 am, 1 pm and 5 pm. As above, since Employee Sam has not activated the relationship-based display for his scheduling software, Employee Sam's availability data remains unfiltered, regardless of who is attempting to schedule a meeting with him.

FIG. 10 depicts an exemplary SSR-enabled scheduling software interface Employee Ted is presented with when attempting to schedule a meeting with Employee Jennifer and/or Employee Sam. Employee Jennifer has classified Employee Ted as among the least important priority rank of users. As in the non-SSR-enabled scheduling software, Employee Ted is presented with Employee Jennifer's true or entire meeting schedule. This availability data shows that Employee Jennifer already has meetings scheduled for every time slot of Sep. 15, 2006 except 12 pm, 3 pm and 4 pm. As with VP Fred and Manager Bob, Employee Ted is presented with Employee Sam's actual, unfiltered availability data.

Alternate embodiments incorporating the SSR option may allow someone other than the scheduling user, such as the invitee or an administrator for example, to selectively enable or disable the SSR option. Other alternate embodiments may provide or enable a default priority rank to be assigned to a user. The default priority rank may be the lowest priority rank available, for example.

Alternate embodiments may allow a user to selectively enable or disable the relationship-based view (RBV). This selective enablement or disablement may be embodied as one or more options, such as a single checkbox or multiple checkboxes, as non-limiting examples. Exemplary embodiments of this design may provide the RBV enablement option to the scheduling user, the invitee or an administrator, as non-limiting examples. Alternate exemplary embodiments incorporating the RBV enablement option may distinguish or identify the priority ranks associated with scheduled meetings when a user chooses to disable the RBV. This may be accomplished by using different colors for different priority ranks or textual labels, as non-limiting examples.

Since the scheduling is undertaken in a unilateral approach, alternate embodiments may incorporate a “penciling in” feature. As a non-limiting example, the penciling in could take a form wherein invitees must confirm or decline meetings scheduled for them. These alternate embodiments may further comprise a system wherein only invitees of the same or higher priority rank than the scheduling user are provided with the option to confirm or decline the meeting. Other alternate embodiments may comprise a system wherein only invitees of a higher priority rank than the scheduling user are provided with the option to confirm or decline the meeting. In such a manner, exemplary embodiments may constrain the unilateral nature of scheduling meetings based on the relative priority ranks of the scheduling user and invitees. In further exemplary embodiments, certain groups or priority ranks of invitees, such as those having a higher priority rank than the scheduling user for example, may retain the ability to decline the meeting while other groups or priority ranks of invitees, such as those having a lower priority rank than the scheduling user for example, do not possess the ability to decline the meeting.

Alternate exemplary embodiments of the invention may incorporate the RBV as filter options. That is, the scheduling software may provide filters for use in accord with viewing schedules and scheduling meetings. The priority ranks may be incorporated as one or more filters or filter options a user can selectively employ.

Although shown in FIGS. 5-10 with regards to a scheduling software interface, these are non-limiting exemplary embodiments. Alternate exemplary embodiments of the invention may be implemented by other means. As additional non-limiting examples, the implementations may vary with respect to the depiction of information, the nature and type of interface with which a user may interact and the literal form of the embodiment (e.g. a computer program product, a device, or a method).

Other exemplary embodiments of the invention may enable a scheduling user to see scheduled events of the other user that the scheduling user had previously scheduled. Alternate embodiments may allow that this feature be selectively enabled or disabled.

As described herein, exemplary embodiments of this invention make use of at least one preexisting data source. That is, exemplary embodiments of this invention are concerned with the manipulation and use of data as provided by or in accord with at least one preexisting data source. In accord with exemplary embodiments of the invention, the at least one preexisting data source comprises resource identifiers coupled with corresponding priority ranks, collectively referred to herein as “the relationship data.” The resource identifiers may take many forms, including employee names, as a non-limiting example. The corresponding priority ranks comprise a hierarchical structure of identifiers. The corresponding priority ranks may take many forms, including textual identifiers, numerical identifiers and alphanumeric identifiers, as non-limiting examples. Alternate exemplary embodiments require that it be possible to ascertain and utilize the relative hierarchical structure of the priority ranks of the at least one preexisting data source and/or the total number of priority ranks of the at least one preexisting data source. Other exemplary embodiments may derive (e.g. obtain) the hierarchical relationship and/or priority ranks without utilizing a data source.

The exemplary embodiments of this invention are operable without specific regard for: where the relationship data is stored (e.g. on a centralized server, locally on individual users' computers); who configures the relationship data (e.g. a centralized individual or administrator, individual users); how the relationship data is configured (e.g. individually on a user-by-user basis, automatically by using a collection of information such as field codes in a personnel database); nor upon what the relationship data is based (e.g. manually-input classifications, address book data, address book information in a user's calendar system, an organizational chart, friend-of-a-friend data, friend-of-a-friend data such as data available through services such as MySpace® or Friendster®, a centralized collection of information such as field codes in a personnel database). Those skilled in the relevant arts will appreciate the various options and choices that are available for interfacing the at least one preexisting data source with exemplary embodiments of the invention, and may be made available and used to advantage to implement the exemplary embodiments of this invention.

Scheduling systems (e.g. software) may incorporate a number of different features. Following is a non-limiting list of examples of features of scheduling systems that may be employed with exemplary embodiments of the invention. The system may be web based and accessible over the internet. The system may utilize colors or color coding to distinguish various elements in the display, particularly scheduled meetings or resources. The system may enable notifications to be provided or sent upon the scheduling of a meeting, the appropriation of a different scheduled meeting's time slot or resource or the double booking of an invitee, location or resource. The system may provide connectivity with e-mail, instant messaging, a web site or a cell phone. The system may allow for multiple display formats, such as daily, weekly or monthly views. The system may display the time slot identifiers along a horizontal row or vertical column. The system may provide textual descriptions of scheduled meetings or resources. The system may enable a user to create and/or utilize custom fields and information. The system may allow a user to produce reports and/or print reports to a printing device. The system may include a search feature. The system may enable users to schedule meetings, vacation time, people, groups, rooms, facilities and other resources. The system may provide an option for automatic scheduling of recurring events. The system may enable a user to send an agenda, notes or other document(s) to invitees before or after the scheduled meeting. The system may enable a user to send reminders to invitees or provide an alarm or reminder for a user for a scheduled meeting. The system may enable a user to export data or information to other programs, formats or devices. The system may provide filters for a user to employ when utilizing the search feature. The system may provide connectivity or interactivity with a user's address book or calendar system. The system may be employed in a variety of operating systems or computing environments. The above features and non-limiting examples thereof are provided as non-limiting examples of aspects of scheduling systems that may be employed with exemplary embodiments of the invention. Those skilled in the relevant arts will appreciate the various options and choices available for interfacing one or more of these features with exemplary embodiments of the invention.

Methods for practicing the exemplary embodiments of this invention present a scheduling user with a relationship-based display of user schedules by using a hierarchical structure of priority ranks. A priority rank of a scheduling user is determined. A view of a user schedule is displayed. The view includes scheduled events of the user that are selected at least partially in accordance with the determined priority rank of the scheduling user.

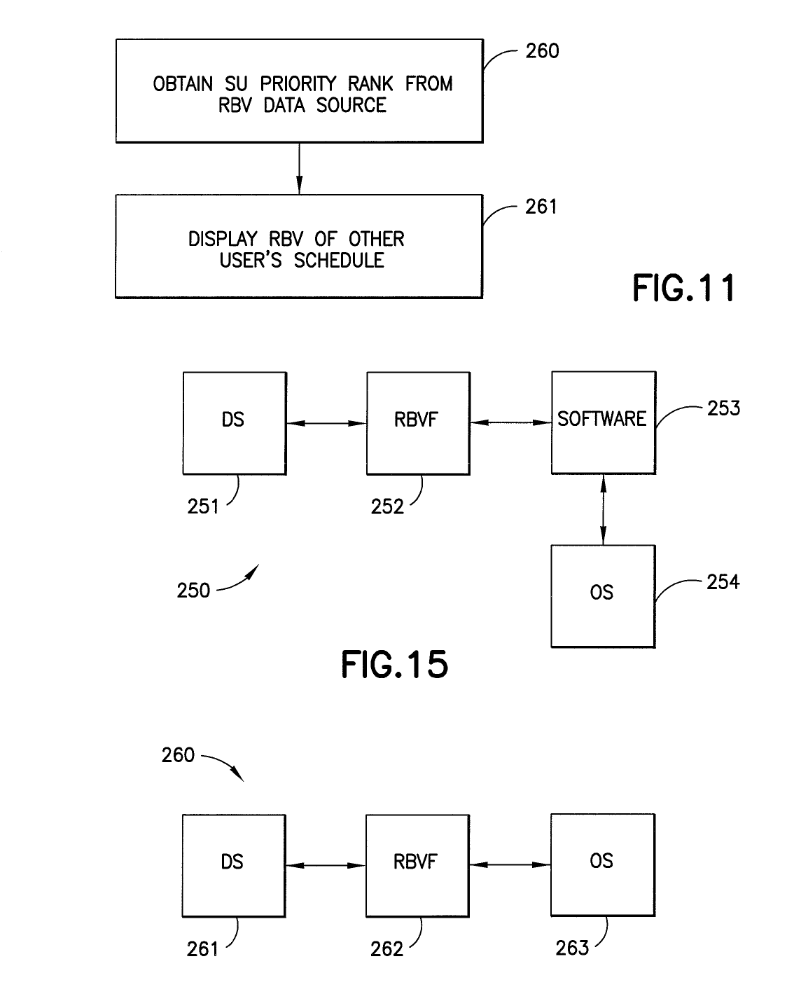

FIG. 11 shows a flow chart illustrating one non-limiting example of a method for practicing the exemplary embodiments of this invention. The method utilizes a hierarchical structure of priority ranks to present a scheduling user with a relationship-based display of user schedules for one or more other users. The method of FIG. 11 includes the following steps. In box 260, the method obtains the scheduling user's (SU) priority rank from the RBV (relationship-based view) data source. In box 261, the method displays the RBV of the other user's schedule, based on the SU's priority rank. Alternate embodiments of the method may include options to selectively enable or disable the RBV. Other alternate embodiments may incorporate the SSR (See Same Rank) option as discussed herein.

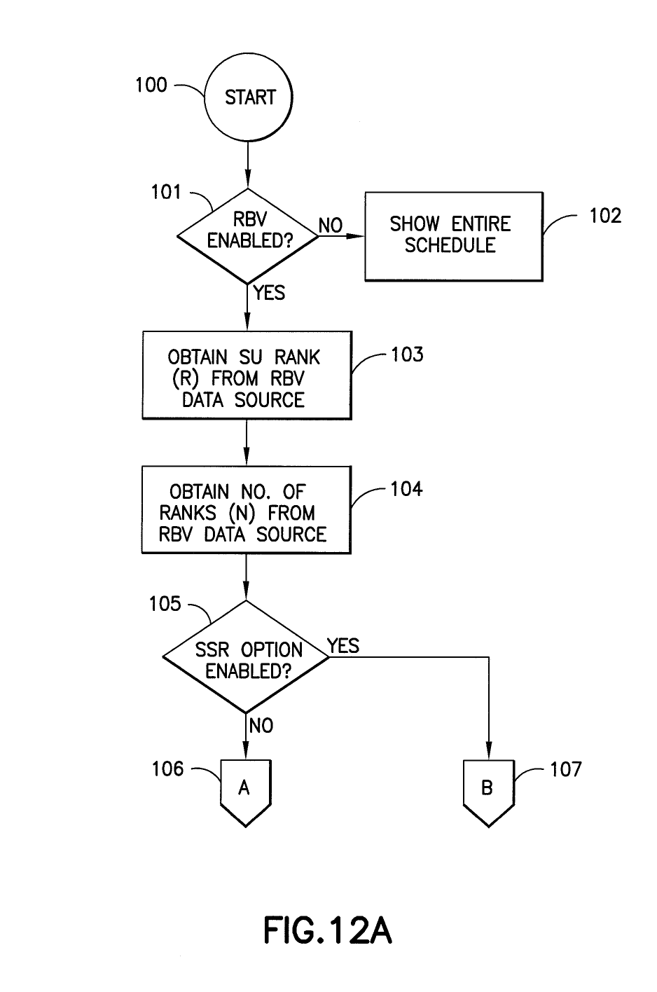

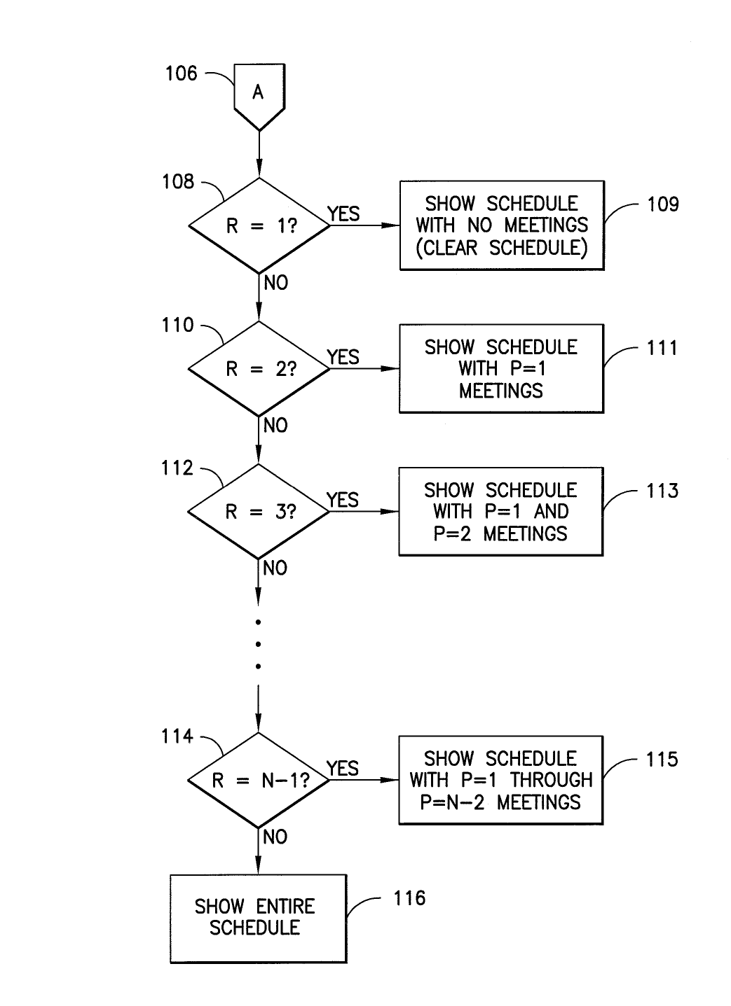

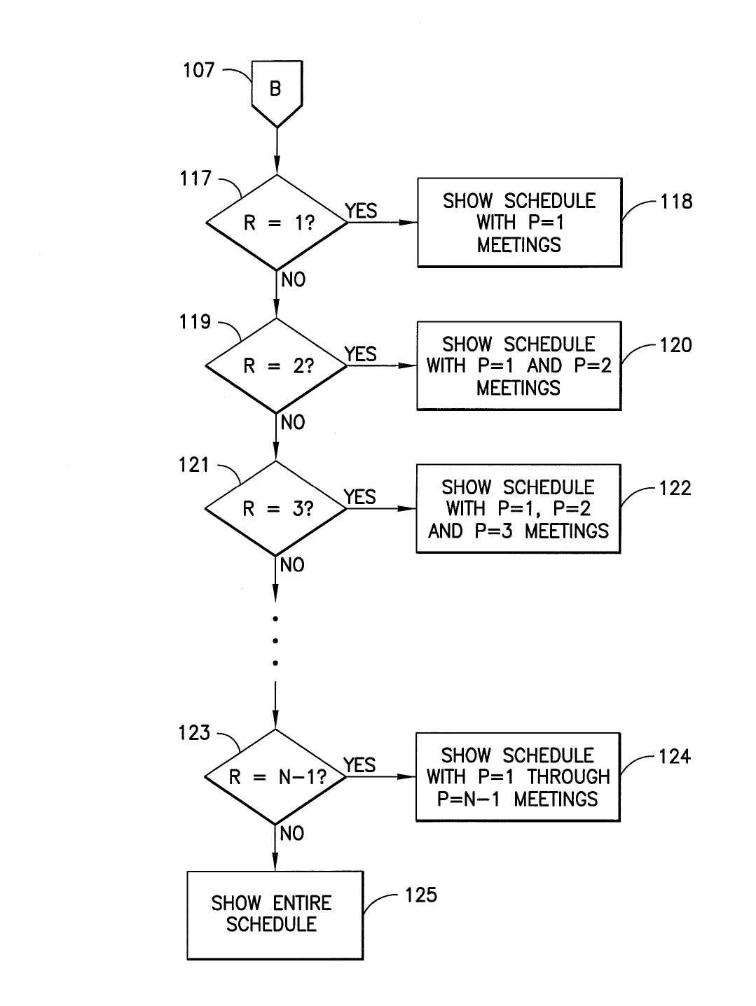

FIGS. 12A-12C depict a flow chart illustrating an alternate exemplary method for practicing the exemplary embodiments of this invention. The method shown in FIGS. 12A-12C may be used to incorporate a hierarchical structure of priority ranks to present various priority ranks of users with a relationship-based display of user schedules. Based on the priority rank of the scheduling user, the method determines what invitee availability data is shown to the scheduling user. The invitee availability data shown may subsequently be employed to assist the scheduling user in scheduling a meeting with the invitee. If more than one invitee will be invited to or scheduled for the meeting, the method or portions of the method may be reiterated for the additional invitee(s).

The method discussed with regards to FIGS. 12A-12C includes the SSR embodiment explained above with regards to FIGS. 8-10. Alternate embodiments of the method may not include the SSR option. Examples of such alternate exemplary embodiments of the method may be obtained by eliminating decision box 105 from FIG. 12A and connecting box 104 with connector boxes 106 and 107 to obtain two alternate non-SSR option exemplary embodiments of the method, respectively. In such a manner, FIGS. 12A and 12B would comprise one embodiment of the method while FIGS. 12A and 12C would comprise another embodiment of the method. As is apparent, FIGS. 12A-12C, as shown and as discussed below, comprise one exemplary embodiment of the method.

Furthermore, the exemplary method discussed with regards to FIGS. 12A-12C includes the RBV enablement option explained above. Other embodiments of the method may not include the RBV enablement option. In such a manner, the method may assume that the RBV is enabled in the system upon which the method is acting.

As discussed below with regards to FIGS. 12A-12C, the priority rank system employed is a numerical system wherein the priority rank identifiers are whole numbers. A priority rank (P) of 1 is the highest priority rank. The priority rank system has N total number of priority ranks with a priority rank of N being the lowest priority rank. Hence, the priority ranks extend from priority rank 1 (P=1) to priority rank N (P=N) in decreasing order of importance. As discussed above, the priority rank system need not utilize numerical identifiers and the system employed in FIGS. 12A-12C is a non-limiting example thereof.

Furthermore, as employed in the discussion of FIGS. 12A-12C, the phrase “P=G meetings” indicates the scheduled meetings the invitee has with a user or users of priority rank G, where 1≦G≦N, numerically.

The exemplary method of FIGS. 12A-12C comprises the following steps. In FIG. 12A, the method begins at start box 100. At decision box 101, the method inquires whether or not the relationship-based view (RBV) is enabled. If the RBV is not enabled, the method proceeds to box 102 and displays the entire, unfiltered schedule of the invitee. If the RBV is enabled, the method proceeds to box 103. In box 103, the method obtains the scheduling user's (SU) priority rank (R) from the RBV data source. In box 104, the method obtains the total number of priority ranks (N) from the RBV data source. At decision box 105, the method inquires whether or not the SSR option is enabled. If the SSR option is not enabled, the method continues on to connector box 106 which leads to FIG. 12B. If the SSR option is enabled, the method continues on to connector box 107 which leads to FIG. 12C.

If the SSR option is not enabled, the method continues from connector box 106 in FIG. 12B. At decision box 108, the method inquires whether R=1. If R=1, the method proceeds to box 109 and shows a clear schedule (the invitee's schedule with no meetings scheduled). If R≠1, the method proceeds to decision box 110. At decision box 110, the method inquires whether R=2. If R=2, the method proceeds to box 111 and shows the invitee's schedule with P=1 meetings. If R≠2, the method proceeds to decision box 112. At decision box 112, the method inquires whether R=3. If R=3, the method proceeds to box 113 and shows the invitee's schedule with P=1 and P=2 meetings. If R≠3, the method proceeds onwards in a similar fashion, where it would reach a decision box inquiring whether R=4 (not shown). The method continues on in this manner until it reaches decision box 114 where it inquires whether R=N−1. If R=N−1, the method proceeds to box 115 and shows the invitee's schedule with P=1 through P=N−2 meetings. In other words, the method shows the invitee's schedule with all meetings being shown except the P=N and P=N−1 meetings. If R≠N−1, the method proceeds to box 116 and shows the entire, unfiltered schedule of the invitee.

If the SSR option is enabled, the method continues from connector box 107 in FIG. 12C. At decision box 117, the method inquires whether R=1. If R=1, the method proceeds to box 118 and shows the invitee's schedule with P=1meetings. If R≠1, the method proceeds to decision box 119. At decision box 119, the method inquires whether R=2. If R=2, the method proceeds to box 120 and shows the invitee's schedule with P=1and P=2 meetings. If R≠2, the method proceeds to decision box 121. At decision box 121, the method inquires whether R=3. If R=3, the method proceeds to box 122 and shows the invitee's schedule with P=1, P=2 and P=3 meetings. If R≠3, the method proceeds onwards in a similar fashion, where it would reach a decision box inquiring whether R=4 (not shown). The method continues on in this manner until it reaches decision box 123 where it inquires whether R=N−1. If R=N−1, the method proceeds to box 124 and shows the invitee's schedule with P=1through P=N−1 meetings. In other words, the method shows the invitee's schedule with all meetings being shown except the P=N meetings. If R≠N−1, the method proceeds to box 125 and shows the entire, unfiltered schedule of the invitee.

As noted above, the flow chart of FIGS. 12A-12C illustrates an exemplary method for practicing the invention. Another embodiment of the method utilizes a hub-inquiry approach as opposed to the logical chain of FIGS. 12A-12C. In this exemplary embodiment, after box 104 the method would inquire as to the value of R (R=?). Such a box would be equivalent to the hub of a wheel having N−1 spokes radiating out from the hub. Each spoke would represent a different numerical value of R, where 1≦R≦N−1. For example, if R=1, the method would follow the R=1 spoke and arrive at a decision box inquiring whether the SSR option is enabled. The decision box would lead to two process boxes, one if the SSR option is not enabled and one if the SSR option is enabled. If the SSR option is not enabled, the destination box would direct that the method show a clear schedule for the invitee, as in box 109 of FIG. 12B. If the SSR option is enabled, the destination box would direct that the method show the invitee's schedule with P=1 meetings, as in box 118 of FIG. 12C. As is apparent, although the literal steps taken and the order of the operations are different from the exemplary method of FIGS. 12A-12C, this embodiment still provides a relationship-based display of availability information.

As another exemplary embodiment, the method would comprise two hubs, one each representing that the SSR option is disabled or enabled. In such a manner, as compared with the embodiment described immediately above, the SSR option enablement inquiry is moved from the individual spokes to its position in FIG. 12A, immediately following box 104. In such a manner, connector boxes 106 and 107 of FIG. 12A would lead to separate hubs, one representing the display outcomes if the SSR option is not enabled and one representing the display outcomes if the SSR option is enabled, respectively.

The exemplary embodiments discussed above of a method for practicing the invention are very similar in terms of the underlying steps and inquiries. For instance, each of the exemplary embodiments inquires what is the value of R and whether the SSR option is enabled. Based on the answers to those two inquiries, the corresponding method produces the appropriate display for a scheduling user.

Although the above disclosure discusses priority ranks in the context of business meetings, alternate embodiments may utilize the hierarchical priority rank structure in a more abstract sense. As a non-limiting example, rather than prioritizing meetings based on the person or persons with whom a user is meeting, the meeting itself may be given an innate priority rank. In such a manner, non-meeting events may utilize the hierarchical priority rank structure in conjunction with scheduling.

Furthermore, although discussed above in the context of business meetings, exemplary embodiments of the invention may incorporate other events or occurrences, including, but not limited to: vacation time, holidays and conferences. As mentioned above, exemplary embodiments of the invention may provide for scheduling of multiple people or groups and non-human resources, such as rooms, facilities and technical equipment, as non-limiting examples.

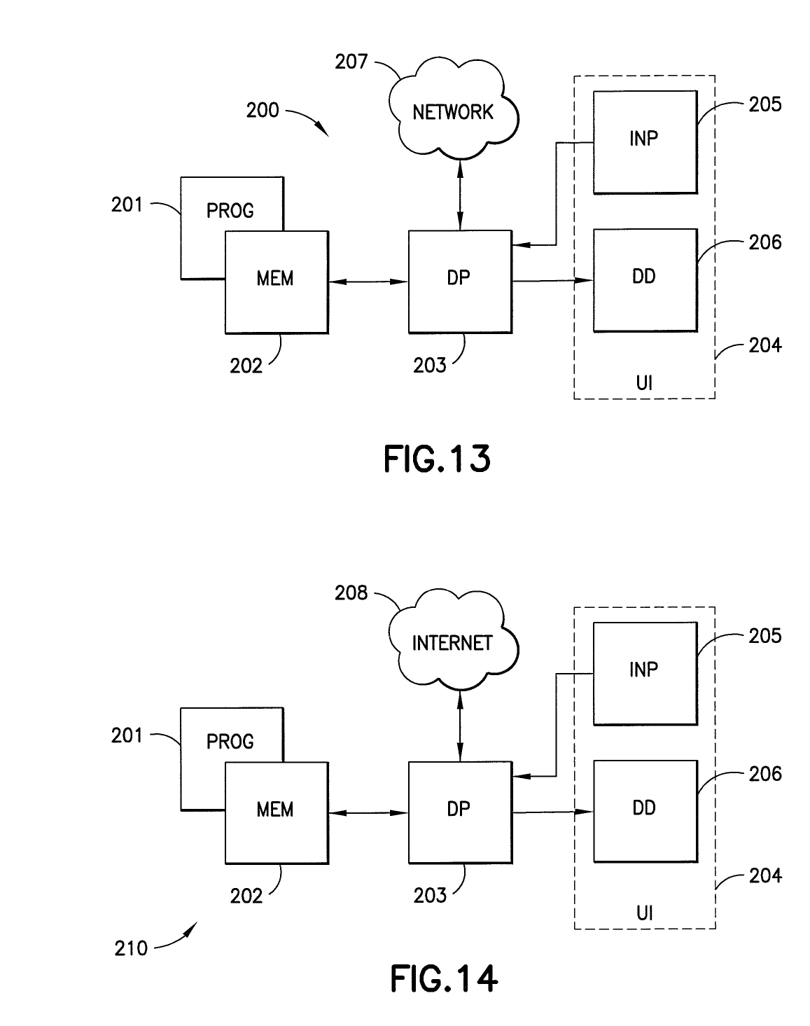

Reference is made to FIGS. 13 and 14 for illustrating a simplified block diagram of an electronic device, such as a computer, that is suitable for use in practicing the exemplary embodiments of this invention. In FIG. 13, the electronic device 200 includes a memory (MEM) 202 that stores program code (PROG) 201, a data processor (DP) 203, and a user interface (UI) 204 comprising at least one input device (INP) 205 and at least one display device (DD) 206. The DP 203 is connected to a Network 207. The Network 207 enables the electronic device 200 to communicate with either a centralized server or other independent electronic devices to facilitate the scheduling of meetings with other users. The PROG 201 is assumed to include program instructions that, when executed by the DP 203, enable the electronic device 200 to operate in accordance with the exemplary embodiments of this invention, as discussed above in greater detail.

FIG. 14 depicts a similar electronic device 210 as the one shown in FIG. 13. The device 210 of FIG. 14 is connected to the Internet 208 or to some other wide-area communications network. The Internet 208 serves a similar function as the Network 207, enabling the electronic device 210 to communicate with either a centralized server or other independent electronic devices to facilitate the scheduling of meetings with other users. In such a manner, the software or system may be accessible over the internet.

The computer program product that operates in accord with exemplary embodiments of the invention may be located on local electronic devices or on a centralized server, as non-limiting examples.

Exemplary embodiments of the invention can take the form of an entirely hardware embodiment, an entirely software embodiment or an embodiment containing both hardware and software elements. In one presently preferred embodiment, the invention is implemented in software, which includes but is not limited to firmware, resident software and/or microcode, as non-limiting examples.

Furthermore, exemplary embodiments of the invention can take the form of a computer program product accessible from a computer-useable or computer-readable medium providing program code for use by or in connection with a computer or any instruction execution system. For the purposes of this description, a computer-useable or computer-readable medium can be any apparatus that can contain, store, communicate, propagate, or transport the program for use by or in connection with the instruction execution system, apparatus, or device.

The medium can be electronic, magnetic, optical, electromagnetic, infrared, a semiconductor system (or apparatus or device) or a propagation medium, as non-limiting examples. Non-limiting examples of a computer-readable medium include a semiconductor or solid state memory, magnetic tape, a removable computer diskette, a random access memory (RAM), a read-only memory (ROM), a rigid magnetic disk and an optical disk. Current, non-limiting examples of optical disks include compact disk-read only memory (CR-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or indirectly through intervening I/O controllers.

Network adapters may also be coupled to the system to enable the data processing system to become coupled to other data processing systems or remote printers or storage devices through intervening private or public networks. Modems, cable modem and Ethernet cards are just a few non-limiting examples of the currently available types of network adapters.

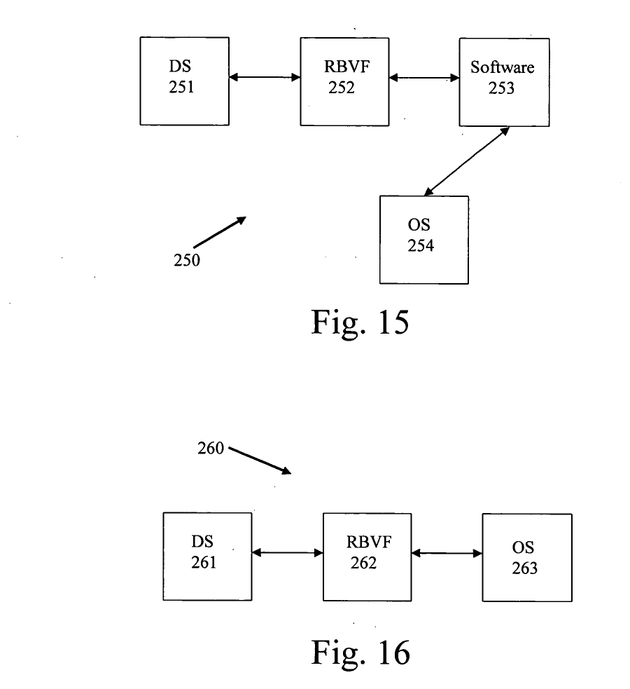

Turning now to FIGS. 15 and 16, simplified block diagrams are presented showing exemplary sets of software interactions involved in implementing various embodiments of the invention. FIG. 15 illustrates an exemplary embodiment of a set of software interactions 250 wherein a relationship-based view function (RBVF) 252, in accordance with exemplary embodiments of the invention, interacts with Software 253 to present various priority ranks of users with a relationship-based display of user schedules. The RBVF 252 additionally interacts with a data source (DS) 251 to acquire information the RBVF needs in order to operate. The Software 253 is assumed to include techniques for displaying calendar availability with the display being affected (e.g. controlled), at least in some portion, by the RBVF 252. The Software 253 additionally interacts with an operating system (OS) 254, in accord with technology and systems known in the art.

FIG. 16 presents a set of software interactions 260 similar to the one shown in FIG. 15. In the set of software interactions 260 of FIG. 16, the Software component has been subsumed by one of the other components. Either the RBVF 262 or the OS 263 is assumed to include techniques for displaying calendar availability with the display being affected (e.g. controlled), at least in some portion, by the RBVF 262. In such a manner, the RBVF 262, in conjunction with the DS 261, may operate in accord with scheduling software aspects provided by the OS 263. In an alternate embodiment, the RBVF 262 may itself provide the scheduling software aspects required for it to operate. A non-limiting example of this embodiment is the RBVF comprising scheduling software that includes elements performing the functions of the RBVF.

Although shown in FIGS. 15 and 16 as two separate components, in alternate embodiments the DS may be subsumed by the RBVF to form a single component. Furthermore, although an OS is included in FIGS. 15 and 16, alternate embodiments may not comprise an OS. A non-limiting example of such an embodiment is an electronic device whose sole function is to act as a calendar or scheduling system. Such a device may not utilize an OS to control or affect the underlying software or software code that is run by the device.

Generally, various exemplary embodiments of the invention can be implemented in different mediums, such as software, hardware, logic, special purpose circuits or any combination thereof. As a non-limiting example, some aspects may be implemented in software which may be run on a computing device, while other aspects may be implemented in hardware.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A computer program product comprising program instructions embodied on a tangible computer-readable medium, execution of the program instructions resulting in operations comprising:
determining a priority rank of a scheduling user; and
displaying a view of a schedule of at least one other user, wherein the view shows scheduled events of the at least one other user that are selected at least partially in accordance with the determined priority rank of the scheduling user.

2. The computer program product of claim 1, wherein the view shows scheduled events of the at least one other user that were previously scheduled by the scheduling user.

3. The computer program product of claim 1, execution of the program instructions resulting in operations further comprising:
enabling the view to show scheduled events of the at least one other user that were previously scheduled by the scheduling user; and
providing a user with an option to selectively enable or disable having the view show scheduled events of the at least one other user that were previously scheduled by the scheduling user.

4. The computer program product of claim 1, wherein the scheduled events of the at least one other user shown by the view consist of scheduled events corresponding to a priority rank of greater importance than the determined priority rank of the scheduling user.

5. The computer program product of claim 1, wherein the scheduled events of the at least one other user shown by the view consist of scheduled events corresponding to a priority rank of equal importance to the determined priority rank of the scheduling user and scheduled events corresponding to a priority rank of greater importance than the determined priority rank of the scheduling user.

6. The computer program product of claim 1, execution of the program instructions resulting in operations further comprising:
enabling the view to show scheduled events of the at least one other user that correspond to a priority rank of equal importance to the determined priority rank of the scheduling user; and
providing a user with an option to selectively enable or disable having the view show scheduled events of the at least one other user that correspond to a priority rank of equal importance to the determined priority rank of the scheduling user.

7. The computer program product of claim 1, execution of the program instructions resulting in operations further comprising providing a user with an option to selectively enable or disable the view.

8. The computer program product of claim 7, execution of the program instructions resulting in operations further comprising in response to the view being disabled, displaying an unfiltered schedule of the at least one other user.

9. An electronic device comprising:
at least one memory comprising a view function; and
at least one data processor coupled to the at least one memory,
wherein the view function is executable by the at least one data processor and
wherein the view function comprises a set of operations comprising:
determining a priority rank of a scheduling user; and
displaying a view of a schedule of at least one other user, wherein the view shows scheduled events of the at least one other user that are selected at least partially in accordance with the determined priority rank of the scheduling user.

10. The electronic device of claim 9, wherein the set of operations further comprises:
enabling the view to show scheduled events of the at least one other user that were previously scheduled by the scheduling user; and
providing a user with an option to selectively enable or disable having the view show scheduled events of the at least one other user that were previously scheduled by the scheduling user.

11. The electronic device of claim 9, wherein the set of operations further comprises:
enabling the view to show scheduled events of the at least one other user that correspond to a priority rank of equal importance to the determined priority rank of the scheduling user; and
providing a user with an option to selectively enable or disable having the view show scheduled events of the at least one other user that correspond to a priority rank of equal importance to the determined priority rank of the scheduling user.

12. The electronic device of claim 9, wherein the set of operations further comprises providing a user with an option to selectively enable or disable the view, wherein in response to the view being disabled, an unfiltered schedule of the at least one other user is displayed.

13. A method comprising:
determining a priority rank of a scheduling user; and
displaying a view of a schedule of at least one other user, wherein the view shows scheduled events of the at least one other user that are selected at least partially in accordance with the determined priority rank of the scheduling user.

14. The method of claim 13, further comprising:
enabling the view to show scheduled events of the at least one other user that were previously scheduled by the scheduling user; and
providing a user with an option to selectively enable or disable having the view show scheduled events of the at least one other user that were previously scheduled by the scheduling user.

15. The method of claim 13, further comprising:
enabling the view to show scheduled events of the at least one other user that correspond to a priority rank of equal importance to the determined priority rank of the scheduling user; and
providing a user with an option to selectively enable or disable having the view show scheduled events of the at least one other user that correspond to a priority rank of equal importance to the determined priority rank of the scheduling user.

16. The method of claim 13, further comprising providing a user with an option to selectively enable or disable the view, wherein in response to the view being disabled, an unfiltered schedule of the at least one other user is displayed.
